(19) United States
(12) Patent Application Publication
(10) Pub. No.: US 2025/0210725 A1
(43) Pub. Date: Jun. 26, 2025

(54) BATTERY AND ASSOCIATED ASSEMBLY METHOD

(71) Applicant: AUTOMOTIVE CELLS COMPANY SE, BRUGES (FR)

(72) Inventors: Pierre CHAUVEAU, BRUGES (FR); Alexandre MATHIEU, BORDEAUX (FR); Gwenaelle BOOS, Eysines (FR); Dimitri MARATHE, VILLENAVE D'ORNON (FR)

(21) Appl. No.: 18/852,177

(22) PCT Filed: Mar. 30, 2023
(86) PCT No.: PCT/EP2023/058269

§ 371 Date: Sep. 27, 2024

(30) Foreign Application Priority Data
Mar. 31, 2022 (EP) 22305416.4

(51) Int. Cl. H01M 10/42; H01M 10/613; H01M 10/625; H01M 10/6557; H01M 50/204; H01M 50/242; H01M 50/249; H01M 50/262; H01M 50/289; H01M 50/502

(52) U.S. Cl. CPC H01M 10/4207; H01M 10/613; H01M 10/625; H01M 10/6557; H01M 50/242; H01M 50/249; H01M 50/262; H01M 50/289; H01M 50/502; H01M 50/204

(57) ABSTRACT

The invention relates to a battery comprising at least two assemblies (16), each of the two assemblies (16) comprising a plurality of electrochemical cells (18) and a central plate (20), the electrochemical cells (18) of each of the two assemblies (16) comprising a first group (34) of electrochemical cells and a second group (36) of electrochemical cells which are separated from one another in the transverse direction (Y) by the central plate (20),

Each of the assemblies (16) is able to move between a use configuration in which the first group (34) and the second group (36) of electrochemical cells are electrically connected to one another and a maintenance configuration in which the first group (34) and the second group (36) of electrochemical cells are electrically disconnected from one another, each of the first group (34) and of the second group (36) of electrochemical cells having a voltage of below 60 V.

The present invention relates to a battery, more particularly for a vehicle which is at least partially powered by an electric battery.

The invention applies more particularly to the production of a battery, in particular for an electric vehicle. “Battery” refers to a plurality of electrochemical cells electrically connected to each other. According to a particular example of a battery, the plurality of electrochemical cells is arranged in the form of one or a plurality of battery module(s), each battery module comprising a plurality of electrochemical cells electrically connected to one another and mechanically assembled to one another by an assembly system, such as assembly plates. An electrochemical cell comprises, more particularly, a stack of positive electrodes connected to one another, and a stack of negative electrodes connected to one another, separated by a separator. The positive electrodes connected to each other form a positive terminal, and the negative electrodes connected to each other form a negative terminal.

However, such cell modules pose a safety problem, in particular during battery maintenance operations.

Indeed, during the maintenance operations, e.g. an operation to replace one of the cells of a module, said module is disconnected from the rest of the battery and is then handled individually.

However, due to the large number of cells forming a module, the total voltage of the module is high, e.g. greater than 60 V. As a result, the handling of each module requires special precautions, in particular the wearing of personal protective equipment, e.g. gloves, in order to prevent a risk of electrocuting the operator. Thereof makes the battery maintenance operations more complex.

One of the goals of the invention is to facilitate the maintenance of a battery while guaranteeing the safety of the user.

To this end, the subject matter of the invention is a battery comprising at least two assemblies extending successively along a longitudinal direction,
each of the two assemblies comprising a plurality of electrochemical cells extending successively along a transverse direction perpendicular to the longitudinal direction, and a central plate extending perpendicular to the transverse direction,
the electrochemical cells of each of the two assemblies comprising a first group of electrochemical cells electrically connected to each other and a second group of electrochemical cells electrically connected to each other, the first group and the second group being separated from each other, along the transverse direction, by the central plate,
the central plate of each of the two assemblies comprising a first face and a second face opposite each other along the longitudinal direction,
each of the assemblies being movable between a use configuration wherein the first group of electrochemical cells and the second group of electrochemical cells are electrically connected to each other and a maintenance configuration wherein the first group of electrochemical cells and the second group of electrochemical cells are electrically disconnected from each other, each of the first group of electrochemical cells and of the second group of electrochemical cells having a voltage of less than 60 V.

According to particular embodiments, the battery comprises one or a plurality of the following optional features, taken individually or according to all technically possible combinations:
each of the assemblies comprises at least one connecting part removably fastened to the central plate, each of the first group of electrochemical cells and of the second group of electrochemical cells being electrically connected to the connecting part via a connection part, when the assembly is in the use configuration;
the first face of the central plate comprises at least one fastening pin, the second face of the central plate defining at least one fastening hole, the central plate of one of the two assemblies being in the longitudinal continuation of the central plate of the other of the two assemblies, the fastening pin of one of the two assemblies being inserted into the fastening hole of the other of the two assemblies;
the first face of the central plate comprises one second fastening pin and a second fastening hole and the second face of the central plate comprises the other second fastening pin and a second fastening hole;
at least one of the fastening holes of the central plate has an oblong shape;
the battery comprises at least one cross-member extending along the transverse direction, the cross-member being interposed longitudinally between the two assemblies along the longitudinal direction;
the cross-member comprises at least one passage hole letting through the fastening pin of the corresponding central plate;
the central plate comprises a third face and a fourth face opposite each other along a third direction perpendicular to the longitudinal direction and to the transverse direction, the third face of the central plate delimiting between one of the electrochemical cells of the first group of electrochemical cells and one of the electrochemical cells of the second group of electrochemical cells, a cavity situated on the side opposite the bottom;
the battery includes electrical connectors fastened onto the third face of the central plate in the cavity;
at least one of the electrical connectors is a busbar;
the central plate comprises an integrated cooling circuit defining at least one passage intended to let a cooling fluid flow therethrough.

A further subject matter of the invention is a method of assembling a battery as described hereinabove, comprising at least the following steps:
a step of assembling each of the two assemblies, and
a step of arranging the two assemblies so that the central plate of one of the two assemblies is in the longitudinal continuation of the central plate of the other of the two assemblies.

According to particular embodiments, the method has one or a plurality of the following optional features, taken individually or according to all technically possible combinations:
the step of assembling each of the two assemblies comprises the removable fastening of a connecting part on the central plate and, for each of the groups, the fastening of a connection part on the connecting part;
the central plate comprises a third face and a fourth face opposite each other along a third direction perpendicular to the longitudinal direction and to the transverse direction, the third face of the central plate delimiting between one of the electrochemical cells of the first group of electrochemical cells and one of the electrochemical cells of the second group of electrochemical cells, a cavity situated on the side opposite the bottom, the method comprising an additional step of fastening electrical connectors onto the third face of the central plate in the cavity.

The invention will be better understood upon reading the following description, given only as an example, but not limited to, and making reference to the enclosed drawings wherein:

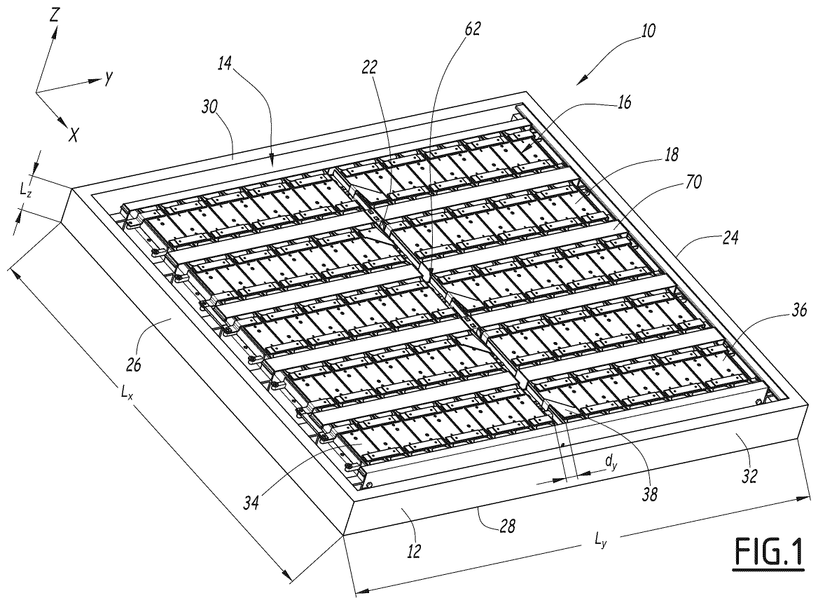

FIG. 1 is a schematic perspective view of a battery according to the invention, comprising a plurality of assemblies,

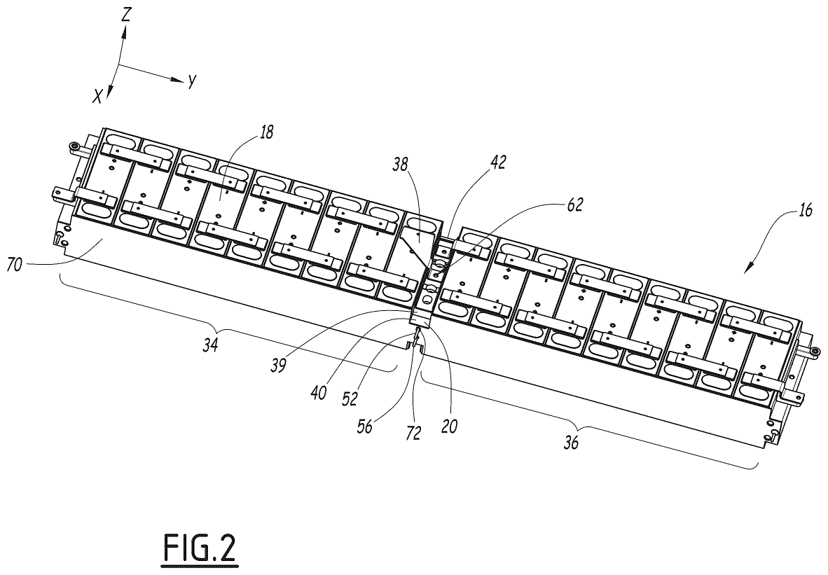

FIG. 2 is a schematic perspective view of an assembly of the battery shown in FIG. 1, comprising electrochemical cells and a central plate,

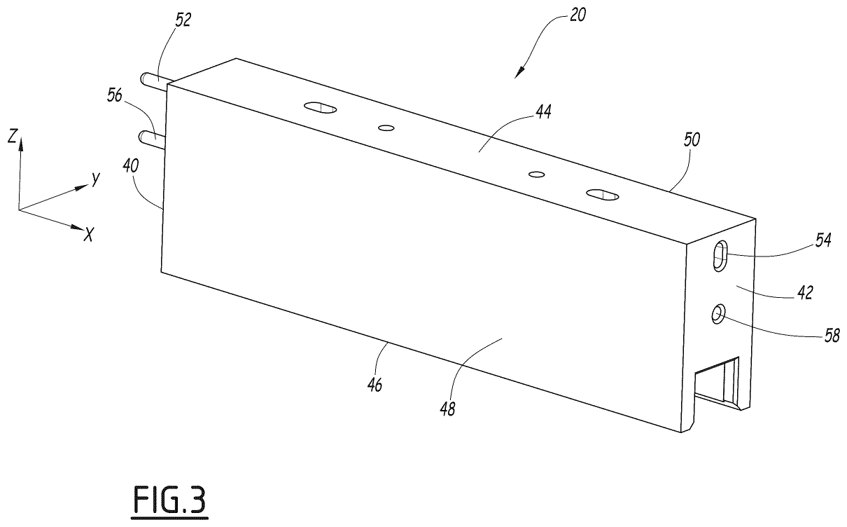

FIG. 3 is a schematic perspective view of one of the central plates of the assembly shown in FIG. 2,

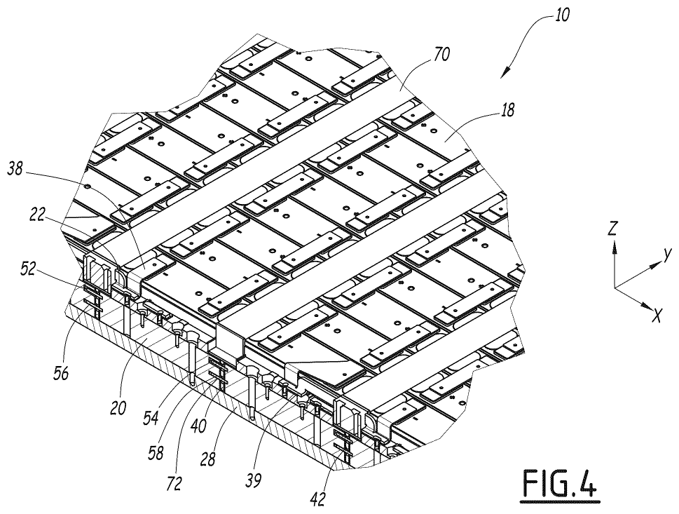

FIG. 4 is a section view along the section plane XZ of the battery shown in FIG. 1, and

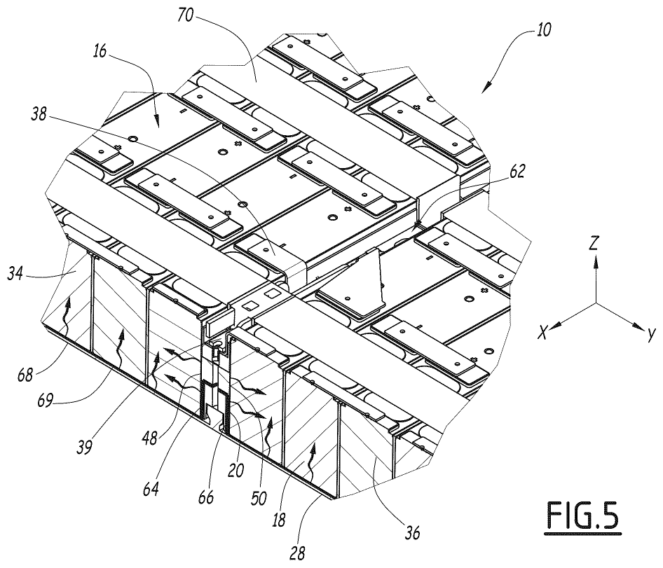

FIG. 5 is a section view along the section plane YZ of the battery shown in FIG. 1.

A battery 10 according to the invention, is described with reference to FIGS. 1 to 5.

The battery 10 is e.g. intended to be placed in an electric or hybrid motor vehicle (not shown).

The battery 10 comprises a housing 12 defining a cavity 14 extending in a longitudinal direction X which is e.g. the direction of advance of the vehicle, and in a transverse direction Y perpendicular to the longitudinal direction and which is e.g. the transverse direction of the vehicle.

A third direction Z is also defined perpendicular to the longitudinal direction X and to the transverse direction Y, and which is e.g. intended to be substantially vertical when the vehicle is situated on a horizontal surface (not shown).

The battery 10 further comprises at least two assemblies 16 extending successively in the longitudinal direction X.

The battery 10 also advantageously comprises electrical connectors 22 arranged between the assemblies 16 to connect the assemblies 16 to each other.

The battery 10 also comprises e.g. fastening members (not shown), such as screws, for fastening the assemblies 16 on the housing 12.

Preferably, the battery 10 further comprises at least one cross-member 70 extending along the transverse direction Y.

In the example shown in FIG. 1, the battery 10 comprises five assemblies 16 and six cross-members 70. Four of the six cross-members 70 are interposed longitudinally between the assemblies 16, and two cross-members 70 are called, longitudinally, “end” cross-members since same run along only one of the assemblies 16, respectively.

According to other embodiments (not shown), the number of assemblies 16 is less than five or more than five, and the number of cross-members 70 is less than six or more than six.

The housing 12 has e.g. a parallelepiped shape, advantageously flattened in the third direction Z, since the battery 10 is e.g. intended to be integrated into the lower part of the vehicle, e.g. under a passenger compartment.

The housing 12 defines a first lateral edge 24 and a second lateral edge 26 opposite each other along the transverse direction Y. The housing further comprises a bottom 28 and a third lateral edge 30 and a fourth lateral edge 32 opposite each other along the longitudinal direction X.

The housing 12 advantageously comprises a cooling circuit 68, preferably provided in the bottom 28 of the housing 12.

The cooling circuit 68 defines e.g. at least one passage 69 intended to let a cooling fluid flow therethrough, e.g. anti-freeze-containing water or cold air, in order to cool the assemblies 16 along the third direction Z.

The electrical connectors 22 are preferably fastened to the assemblies 16.

Preferably, at least one of the electrical connectors 22 is an interconnection bar (or busbar according to the English terminology), e.g. made of copper or aluminum, electrically connecting two adjacent assemblies 16 to each other.

Each cross-member 70 extends e.g. in the transverse direction Y between the first lateral edge 24 and the second lateral edge 26 of the housing 12.

Preferably, the cross-member 70 is interposed longitudinally between two assemblies 16 along the longitudinal direction X, and advantageously so that there is no mechanical play between the cross-member 70 and the assemblies 16.

In the example illustrated in FIG. 1, the cross-members 70 and the assemblies 16 are advantageously arranged successively in the cavity 14 against each other along the longitudinal direction X and alternately, so that there is no mechanical play between the cross-members 70 and the assemblies 16, the assemblies 16 and the cross-members 70 being fastened to the housing 12. Thereby, the cross-members 70 are less prone to buckling in the event of a lateral impact (along the transverse direction Y) on the vehicle, since same are held by the assemblies 16.

Each cross-member 70 advantageously comprises at least one passage hole 72 intended to fasten the cross-member 70 to one of the assemblies 16 as will be described hereinafter.

Each of the assemblies 16 comprises a plurality of electrochemical cells 18 extending successively along the transverse direction Y and preferably secured to each other. Furthermore, each of the assemblies 16 comprises a central plate 20 extending perpendicularly to the transverse direction Y, the electrochemical cells 18 being situated transversely on both sides of the central plate 20.

As illustrated in FIG. 2, each of the assemblies 16 thereby comprises a first group 34 of electrochemical cells electrically connected to each other and a second group 36 of electrochemical cells electrically connected to each other, the first group 34 and the second group 36 being separated from each other, along the transverse direction Y, by the central plate 20.

In the example illustrated in the Figures, each of the assemblies 16 is divided into two groups 34, 36 each including nine electrochemical cells 18.

Each of the assemblies 16 is movable between a use configuration wherein the first group 34 of electrochemical cells and the second group 36 of electrochemical cells are electrically connected to each other and a maintenance configuration in which the first group 34 of electrochemical cells and the second group 36 of electrochemical cells are electrically disconnected from each other.

Each of the assemblies 16 in the use configuration has a voltage e.g. greater than 60 V.

The voltage of an assembly 16 corresponds to the maximum voltage of each of the cells 18 multiplied by the number of cells 18.

Preferably, each of the assemblies 16 comprises at least one connecting part 39 removably fastened to the central plate 20. e.g. by screwing or clipping, the connecting part 39 being apt to electrically connect the cells 18 of the first group 34 with the cells 18 of the second group 36.

Advantageously, each of the first group 34 of electrochemical cells and of the second group 36 of electrochemical cells has a voltage of less than 60 V, which permits safe handling of each of the groups 34, 36.

Each of the first group 34 of electrochemical cells and of the second group 36 of electrochemical cells is advantageously electrically connected to the connecting part 39 by means of a connection part 38 when the assembly 16 is in the use configuration. The two groups 34, 36 of electrochemical cells are thereby electrically connected to each other so as to form the assembly 16 in the configuration of use.

The connection part 38 of each of the groups 34, 36 is fastened, e.g. by welding, to one of the cells 18 of the corresponding group 34, 36.

Preferably, the connection part 38 of each of the groups 34, 36 is fastened to the connection part 39 when the assembly 16 is in the use configuration.

It is thereby easy to electrically disconnect each of the groups 34, 36 independently of the rest of the assembly 16 and of the battery 10, preferably by disconnecting the connecting part 39 from the central plate 20. The assembly 16 is thereby changed to the maintenance configuration.

As illustrated in FIG. 3, the central plate 20 of each of the assemblies 16 has a substantially parallelepipedal shape and comprises a first face 40 and a second face 42 opposite each other along the longitudinal direction X, a third face 44 and a fourth face 46 opposite each other along the third direction Z and a fifth face 48 and a sixth face 50 opposite each other along the transverse direction Y.

The fifth face 48 and the sixth face 50 respectively, of the central plate 20 extends against one of the electrochemical cells 18 of the first group 34, and one of the electrochemical cells 18 of the second group 36 respectively, of the corresponding assembly 16.

As illustrated in FIGS. 1, when the assemblies 16 are mounted in the housing 12, the central plates 20 of the assemblies 16 extend longitudinally from one another.

Furthermore, optionally, the central plate 20 of each of the assemblies 16 advantageously comprises an integrated cooling circuit 64.

The central plates 20 are advantageously suitable for resisting longitudinal forces which would be applied thereto by the cross-member(s) 70, and thus contribute to reducing the risk of buckling of the cross-member(s) 70 in the event of a lateral impact on the vehicle.

As illustrated in FIG. 5, the height of the central plate 20 measured along the third direction Z between the third face 44 and the fourth face 46 of the housing 12 is preferably less than the height of the cells 18 of the assembly 16, the fourth face 46 extending against the bottom 28 of the housing 12.

Thereby, the third face 44 of each central plate 20 delimits, between one of the electrochemical cells 18 of the first group 34 of electrochemical cells and one of the electrochemical cells 18 of the second group 36 of electrochemical cells, a cavity 62 situated on the side opposite the bottom 28 of the housing.

The cavities 62 of the central plates 20 of the assemblies 16 preferably extend longitudinally from one another when the assemblies 16 are mounted in the housing 12.

Advantageously, the connecting part 39 and electrical connectors 22 are fastened to the third face 44 of the central plates 20 in the cavities 62.

Preferably, in the case of an electrical connector 22 which is a busbar, a first end of the busbar is e.g. fastened to the third face 44 of the central plate 20 in the cavity 62 of one of the two assemblies 16 and the second end of the busbar is e.g. fastened to the third face 44 of the central plate 20 in the cavity 62 of the other of the two assemblies 16.

Advantageously, the height of the cavities 62 is adapted so that the electrical connectors 22 and the connecting part 39 are housed entirely in the cavities 62, and more particularly do not project along the third direction Z.

As illustrated in FIG. 5, in each central plate 20, the integrated cooling circuit 64 defines at least one passage 66 intended to let a cooling fluid flow therethrough, e.g. anti-freeze-containing water or cold air. The passage 66 is e.g. connected to the circuit 68 formed in the bottom 28 of the housing 12 and more particularly to the passage 69.

As shown schematically by the arrows in FIG. 5, such an arrangement advantageously makes it possible to cool the electrochemical cells 18 of each of the assemblies 16 along the third direction Z by the circuit 68 in the bottom 28 of the housing 12 and also transversely, by the circuits 64 integrated into the central plates 20.

According to the invention, the first face 40 of each central plate 20 comprises at least one fastening pin 52 extending longitudinally and protruding from the central plate 20, and the second face 42 of the central plate 20 defines at least one fastening hole 54.

Advantageously, as illustrated in FIG. 3, the first face 40 of the central plate 20 comprises a second fastening pin 56 and the second face 42 of the central plate 20 comprises a second fastening hole 58.

Preferably, each of the fastening pins 52, 56 has been fastened to the central plate 20 by fitting in.

In a variant, each of the fastening pins 52, 56 has been fastened to the central plate 20 by welding or bonding.

Each of the fastening holes 54, 58 is provided with a shape and size corresponding to the fastening pin(s) 52, 56.

Advantageously, at least one of the fastening holes 54 of the central plate 20 has an oblong shape, and more particularly with the large dimension thereof along the third direction Z.

As illustrated in FIG. 4, two adjacent assemblies 16 are fastened together by the longitudinal insertion of the fastening pin(s) 52, 56 of one of the two assemblies 16 into the fastening hole(s) 54, 58 of the other of the two assemblies 16, so that the central plate 20 of one of the two assemblies 16 is in the longitudinal continuation of the central plate 20 of the other of the two assemblies 16.

In a variant (not illustrated), the first face 40 comprises a second fastening hole 58 and the second face 42 comprises a second fastening pin 56.

In such variant, during the fastening of two adjacent assemblies 16, the first fastening pin 52 of one of the two assemblies 16 is inserted longitudinally into the first fastening hole 54 of the other of the two assemblies 16 and the second fastening pin 56 of the other of the two assemblies 16 is inserted longitudinally into the second fastening hole 58 of one of the two assemblies 16.

A method of assembling the battery 10 according to the invention will now be described.

The method comprises a step of assembling each of the two assemblies 16.

To this end, a first group 34 of electrochemical cells, a second group 36 of electrochemical cells and a central plate 20 as described hereinabove, are provided.

The central plate 20 is then arranged in such a way that the fifth face 48 and the sixth face 50 respectively of the central plate 20 extends against one of the electrochemical cells 18 of the first group 34 and one of the electrochemical cells 18 of the second group 36 respectively.

Preferably, the assembly step comprises the removable fastening of the connecting part 39 and, for each of the groups 34, 36, the fastening of the connecting part 38 to the connecting part 39, e.g. by screwing or clipping, the assembly 16 thereby having changed to the use configuration.

In the preferred embodiment of the invention, the method comprises a step of providing at least one cross-member 70 and a step of fastening same to one of the assemblies 16, e.g. by inserting the fastening pin(s) 52, 56 of the corresponding central plate 20 into the passage hole(s) 72 of the cross-member 70.

The method then comprises a step of arranging the two assemblies 16 so that the central plate 20 of one of the two assemblies 16 is in the longitudinal continuation of the central plate 20 of the other of the two assemblies 16.

To this end, the method comprises e.g. a step of inserting the fastening pin(s) 52, 56 of one of the two assemblies 16 into the fastening hole 54, 58 of the other of the two assemblies 16, followed by a step of moving one of the assemblies 16 toward the other of the two assemblies 16 along the longitudinal direction (X), more particularly until the fastening pin or pins 52, 56 are fully inserted into the fastening hole(s) 54, 58.

The method advantageously then comprises an additional step of fastening the electrical connectors 22 to the third face 44 of the central plates 20 in the cavities 62.

Due to the features described hereinabove, the maintenance of a battery 10 according to the invention is facilitated and the risks to the safety of the user are limited. Indeed, each of the assemblies 16 is easily electrically separable into two groups 34, 36 of electrochemical cells 18 that can be handled independently of each other and that each has a voltage of less than 60 V, which allows the latter to be handled safely.

Furthermore, the central plates 20 according to the invention make it possible to mechanically reinforce the battery 10, and in particular reduces the risk of buckling of the cross-member(s) 70 in the event of a lateral impact on the vehicle.

Furthermore, such mechanical reinforcement of each cross-member 70 has the advantage of serving to install one or more cross-members 70 with small thickness.

Moreover, the cavities 62 defined by the central plates 20 make it possible to increase the compactness of the battery 10. Indeed, the cavities 62 define a volume Lₓ×L_{z}×d_{y} (with d_{y} corresponding to the width of the cavities 62) that is less than the volume Lₓ×(L_{y}−d_{y})×d_{z} that would be necessary if the electrical connectors 22 were arranged in a layer with a height d_{z} above the cells 18.

The two advantages thereby allow the energy density of the battery 10 to be significantly increased.

Moreover, the cooling circuit 64 integrated in each central plate 20 permits efficient cooling of each of the electrochemical cells 18 and thereby prevents an overheating of the battery 10.

1-14. (canceled)

15. A battery comprising at least two assemblies extending successively along a longitudinal direction,
each of the two assemblies comprising a plurality of electrochemical cells extending successively along a transverse direction perpendicular to the longitudinal direction, and a central plate extending perpendicular to the transverse direction,
the electrochemical cells of each of the two assemblies comprising a first group of electrochemical cells electrically connected to each other and a second group of electrochemical cells electrically connected to each other, the first group and the second group being separated from each other, along the transverse direction, by the central plate,
the central plate of each of the two assemblies comprising a first face and a second face opposite each other along the longitudinal direction,
wherein each of the assemblies is movable between a use configuration wherein the first group of electrochemical cells and the second group of electrochemical cells are electrically connected to each other and a maintenance configuration wherein the first group of electrochemical cells and the second group of electrochemical cells are electrically disconnected from each other, each of the first group of electrochemical cells and the second group of electrochemical cells having a voltage of less than 60 V.

16. The battery according to claim 15, wherein each of the assemblies comprises at least one connecting part removably fastened to the center plate, each of the first group of electrochemical cells and of the second group of electrochemical cells being electrically connected to the connecting part through a connection part, when the assembly is in the use configuration.

17. The battery according to claim 15, wherein the first face of the central plate comprises at least one fastening pin, the second face of the central plate defining at least one fastening hole, the central plate of one of the two assemblies being in the longitudinal continuation of the central plate of the other of the two assemblies, the fastening pin of one of the two assemblies being inserted into the fastening hole of the other of the two assemblies.

18. The battery according to claim 17, wherein the first face of the center plate comprises one second fastening pin and a second fastening hole and the second face of the center plate comprises the other second fastening pin and a second fastening hole.

19. The battery according to claim 17, wherein at least one of the fastening holes of the center plate has an oblong shape.

20. The battery according to claim 15, comprising at least one cross-member extending along the transverse direction, the cross-member being interposed longitudinally between the two assemblies along the longitudinal direction.

21. The battery according to claim 17, comprising at least one cross-member extending along the transverse direction, the cross-member being interposed longitudinally between the two assemblies along the longitudinal direction.

22. The battery according to claim 21, wherein the cross-member comprises at least one passage hole letting through the fastening pin of the corresponding central plate.

23. The battery according to claim 15, wherein the central plate comprises a third face and a fourth face opposite each other along a third direction perpendicular to the longitudinal direction and to the transverse direction, the third face of the central plate delimiting, between one of the electrochemical cells of the first group of electrochemical cells and one of the electrochemical cells of the second group of electrochemical cells, a cavity located on the opposite the bottom.

24. The battery according to claim 23, comprising electrical connectors fastened to the third face of the center plate in the cavity.

25. The battery according to claim 24, wherein at least one of the electrical connectors is a busbar.

26. The battery according to claim 15, wherein the central plate comprises an integrated cooling circuit defining at least one passage intended to let a cooling fluid flow therethrough.

27. A method of assembling a battery according to claim 15, comprising at least the following steps:
a step of assembling each of the two assemblies, and
a step of arranging the two assemblies so that the central plate of one of the two assemblies is in the longitudinal continuation of the central plate of the other of the two assemblies.

28. The method according to claim 27, wherein the step of assembling each of the two assemblies comprises the removable fastening of a connecting part on the central plate and, for each of the groups, the fastening of a connection part on the connecting part.

29. The method according to claim 27, wherein the central plate comprises a third face and a fourth face opposite each other along a third direction perpendicular to the longitudinal direction and to the transverse direction, the third face of the central plate delimiting, between one of the electrochemical cells of the first group of electrochemical cells and one of electrochemical cells the second group of electrochemical cells, a cavity located on the side opposite the bottom, the method comprising an additional step of fastening the electrical connectors onto the third face of the central plate in the cavity.
